(19) United States
(12) Patent Application Publication
(10) Pub. No.: US 2026/0169746 A1
(43) Pub. Date: Jun. 18, 2026

(54) DEVICE, METHOD AND SYSTEM FOR CROSS-CLUSTER COMMUNICATION OF OPERAND VALUES

(71) Applicant: Intel Corporation, Santa Clara, CA (US)

(72) Inventors: Rafael Trapani Possignolo, Hillaboro, OR (US); Roger Gramunt, Portland, OR (US); Jonathan Hall, Portland, OR (US); Srikanth Srinivasan, Portland, OR (US); Henry Wong, Hillsboro, OR (US); Freddy Torres, Portland, OR (US); Brian Hickmann, Sherwood, OR (US); Alexey Suprun, Beaverton, OR (US); Rohan Sharma, Hillsboro, OR (US); Matthew Day, Austin, TX (US); William Griffin, Hillsboro, OR (US); Anurakti Swarup, Hillsboro, OR (US); Gayatri Balachandran, Bothell, WA (US); Patrick Lowry, Highlands Ranch, CO (US)

(73) Assignee: Intel Corporation, Santa Clara, CA (US)

(21) Appl. No.: 18/986,355

(22) Filed: Dec. 18, 2024

(51) Int. Cl. G06F 9/34; G06F 9/24; G06F 9/30

(52) U.S. Cl. CPC G06F 9/34; G06F 9/24; G06F 9/30032; G06F 9/30098

(57) ABSTRACT

Techniques and mechanisms for communicating information between clusters of a processor. In an embodiment, a processor core comprises circuitry to identify a condition wherein a first micro-operation (uop) of a uop sequence is to produce a value of an operand, a second uop of the uop sequence is to use the value of the operand, and different respective clusters of processor resources are to execute the first uop and the second uop. Based on the condition, the processor core supplements a strand of uops with a cross-cluster communication uop, wherein the strand comprises one of the first uop or the second uop. In another embodiment, one of the clusters executes the cross-cluster communication uop to provide a value of the operand to another cluster via a cross-cluster network.

### BACKGROUND

### 1. Technical Field

This disclosure generally relates to processor operations and more particularly, but not exclusively, to the communication of operand values between clusters of a processor.

### 2. Background Art

Advances in semiconductor processing and logic design have permitted an increase in the amount of logic that may be included in processors and other integrated circuit devices. As a result, many processors now have multiple to many cores that are monolithically integrated on a single integrated circuit or die. The multiple cores generally help to allow multiple threads or other workloads to be performed concurrently, which generally helps to increase execution throughput.

Clustered processor microarchitectures divide various hardware structures and resources, which in other architectures are relatively monolithic and large, into smaller parts (the clusters), so that their physical implementation becomes simpler, and hardware scalability is improved, as each of the parts has lower latency and can run at higher clock frequency than corresponding monolithic hardware structures of other processors. A typical application of a clustered microarchitecture is in a wide-issue processor design that divides physical register file resource into two or more smaller clusters, e.g., wherein functionality of an 8-wide out-of-order processor is implemented as two 4-wide monolithic execution clusters and runs at clock frequency of a 4-wide processor.

As successive generations of processor architectures continue to increase in size, variety, and capability, there is expected to be an increasing premium placed on improvements to the efficient provisioning of information between execution resources.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to communicate information between clusters of a processor according to an embodiment.

FIG. 2 shows a flow diagram illustrating features of a method to identify a processor cluster which is to receive an operand value according to an embodiment.

FIG. 3 shows a block diagram illustrating features of a processor core to facilitate a cross-cluster provisioning of operands in a processor according to an embodiment.

FIG. 4 shows a data diagram illustrating a sequence of microoperations which is supplemented to facilitate cross-cluster communication according to an embodiment.

FIG. 5 shows a flow diagram illustrating features of a method to provide cross-cluster communication microoperations in respective strands according to an embodiment.

FIG. 6 shows a block diagram illustrating features of a processor to enable a wake-up of circuitry at a cluster of a processor according to an embodiment.

FIG. 7 shows a block diagram illustrating features of a processor to identify microoperations to be retired at a processor comprising multiple clusters according to an embodiment.

FIG. 8 illustrates an exemplary system.

FIG. 9 illustrates a block diagram of an example processor that may have more than one core and an integrated memory controller.

FIG. 10A is a block diagram illustrating both an exemplary in-order pipeline and an exemplary register renaming, out-of-order issue/execution pipeline according to examples.

FIG. 10B is a block diagram illustrating both an exemplary example of an in-order architecture core and an exemplary register renaming, out-of-order issue/execution architecture core to be included in a processor according to examples.

FIG. 11 illustrates examples of execution unit(s) circuitry.

FIG. 12 is a block diagram of a register architecture according to some examples.

### DETAILED DESCRIPTION

Embodiments described herein variously provide techniques and mechanisms for communicating information between clusters of a processor. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

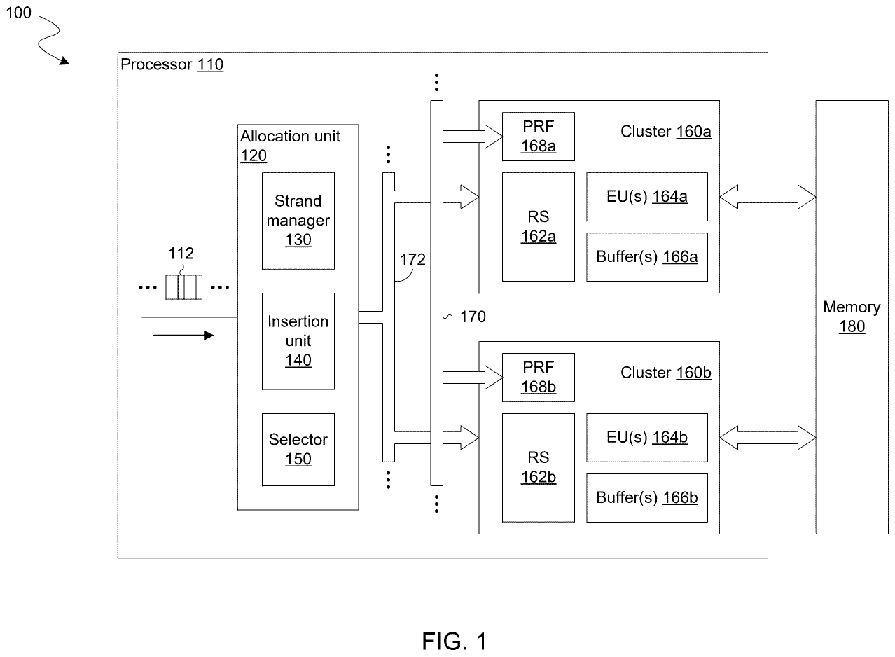

FIG. 1 shows a system 100 for communicating information between clusters of a processor according to an embodiment. System 100 illustrates features of one example embodiment which enables the value of an operand to be communicated from one cluster of a processor, to facilitate execution of a micro-operation (uop) at another cluster of that same processor.

As shown in FIG. 1, system 100 comprises system 100 comprises a processor 110 and a memory 180 coupled thereto. Processor 110 is adapted, for example, from any of various suitable single-core or multi-core processors which provide clustered processing resources. In the example embodiment shown, processor 110 comprises an allocation unit 120 and clusters 160 of processor resources. Allocation unit 120 is configured to receive a sequence 112 of micro-operations (uops) that, for example, are generated by a front-end (not shown) of processor 110. In one such embodiment, the front-end fetches and decodes software instructions to generate uops of sequence 112. Some embodiments are not limited with respect to how sequence 112 is provided to allocation unit 120.

In an embodiment, allocation unit 120 is coupled, via one or more interconnect structures (e.g., including the illustrative interconnect 172 shown), to variously provide uops of sequence 112 each to a respective one of clusters 160. Clusters 160 comprise respective circuit resources variously execute uops which are received from allocation unit 120 via interconnect 172. By way of illustration and not limitation, cluster 160a comprises one or more execution units (EUs) 164a, and a reservation station (RS) 162a which is configured to schedule the execution of uops each by a respective one of EU(s) 164a. Cluster 160a further comprises a physical register file (PRF) 168a which includes physical registers that are available for information which is to be loaded, stored and/or otherwise used with the EU(s) 164a—e.g., wherein some or all such information is communicated between cluster 160a and memory 180. Although some embodiments are not limited in this regard, cluster 160a further comprises one or more buffers 166a—e.g., including a load buffer, a store buffer, a reorder buffer (ROB) and/or the like—which facilitate a provisioning of information associated with the execution of uops with one or more execution units 164a. In one such embodiment, cluster 160b similarly comprises a reservation station (RS) 162b, EU(s) 164b, a PRF 168b, and one or more buffers 166b which, for example, correspond functionally to RS 162a, EU(s) 164a, PRF 168a, and one or more buffers 166a (respectively).

Some embodiments variously facilitate efficient execution of software by providing a cross-cluster communication mechanism which, for example, enables an availability of an operand value to multiple processor clusters. Various embodiments also improve the flexibility with which a processor defines strands (e.g., sets of respective consecutive uops in sequence 112) which are to be allocated for execution each by a respective one of multiple processor clusters.

By way of illustration and not limitation, allocation unit 120 includes, is coupled to access, or otherwise operates with, a strand manager 130 comprising circuitry to detect a first strand of sequence 112 and a second strand of sequence 112, wherein the first strand and the second strand each comprise a respective component set of one or more uops. By way of illustration and not limitation, strand manager 130 designates one or more bounds of a given strand (e.g., a beginning of the strand and/or an end of the strand) based on any of various suitable constraints including, but not limited to, a threshold maximum number of live-in operands, a threshold maximum number of live-out operands, a threshold maximum number of uops, and/or the like.

Strand manager 130 provides functionality to identify a condition (referred to herein as a “live-in/live-out condition”) wherein a uop of one strand is to produce a value of some operand, and wherein another uop of the different strand (which follows the one strand in a program sequence) is to use the value of that same operand. With respect to a given live-in/live-out condition, the term “producer uop” refers herein to the uop which produces (e.g., initially determines) the value of the operand in question, wherein the term “consumer uop” refers herein to the other uop which uses (“consumes”) the value of that same operand. Such a consumer uop depends upon the corresponding producer uop at least insofar as the consumer uop relies upon operations—which include, or take place in preparation for, execution of the producer uop—to determine the value of the operand in question. As used herein, “live-in operand” refers to the relevant operand in a producer uop of a live-in/live-out condition, wherein a “live-out operand” is the relevant operand of a consumer uop of a live-in/live-out condition.

Referring again to FIG. 1, allocation unit 120 further includes, is coupled to access, or otherwise operates with, an insertion unit 140 which is coupled to strand manager 130. Based on the detection of a live-in/live-out condition by strand manager 130, insertion unit 140 supplements a strand with a uop—referred to herein as a “cross-cluster communication uop” or a “xmov uop”—which is to request a communication of information between physical registers of different respective clusters.

In an illustrative scenario according to one embodiment, a xmov uop comprises an opcode field which is to identify the uop as being of a xmov uop type. In one such embodiment, the xmov uop further comprises a first one or more fields which are to specify or otherwise indicate an operand, the value of which is to be read or otherwise retrieved for cross-cluster communication. For example, the first one or more fields are to identify a label of the operand in question. Alternatively or in addition, the first one or more fields identify a location from which the operand value is to be retrieved—e.g., wherein the first one or more fields identify a cluster which is to be a source of the operand value, and/or a particular register in a PRF of said cluster. In some embodiments, the xmov uop further comprises a second one or more operand fields which are to specify or otherwise indicate a location to which the operand value is to be copied, moved or otherwise provided—e.g., wherein the second one or more operand fields identify a cluster which is to receive the operand value, and/or a particular register of a PRF of said cluster.

In an embodiment, cross-cluster communication based on a xmov uop is to take place by a network which couples physical register files (PRFs) of different respective processor clusters to each other. By way of illustration and not limitation, processor 110 further comprises a cross-cluster network 170 which is coupled to the respective PRFs 168a, 168b of clusters 160a, 160b. For example, cross-cluster network 170 is distinct from interconnect 172, and/or is coupled to PRFs 168a, 168b via a path which excludes interconnect 172 (and excludes RSs 162a, 162b, for example).

For a given strand has been supplemented by insertion unit 140 with a xmov uop, a selector 150 of allocation unit 120 selects a processor cluster—e.g., a particular one of clusters 160a, 160b—to execute said strand. The supplemented strand is subsequently executed by the receiving cluster which, based on the execution of the xmov uop, participates in a communication of an operand value, via cross-cluster network 170, between the respective PRFs of two clusters.

In an illustrative scenario according to one embodiment, strand manager 130 detects that a first strand includes a first uop which is to produce a value of an operand, and that a second strand (which follows the first strand in sequence 112) includes a second uop which is to use—i.e., which depends upon - the value of that same operand. For example, a second operand of the second uop is the same as the first operand of the first uop, wherein evaluation of the first operand, for the purpose of enabling execution (e.g., non-speculative execution) of the first uop is sufficient for evaluating the (identical) second operand. Strand manager 130 further determines that this live-in/live-out condition is for strands which are to be executed with different respective processor clusters—e.g., wherein selector 150 selects cluster 160a to execute the first strand and further selects cluster 160b to execute the second strand.

Based on the detected live-in/live-out condition, strand manager 130 signals insertion unit 140 to insert a xmov uop into one of the first strand or the second strand, wherein execution of the xmov uop is to communicate a value of the first operand between PRF 168a and PRF 168b via cross-cluster network 170. In various embodiments, the xmov uop is inserted into the first strand, wherein cluster 160a executes the xmov uop to communicate the operand value, via cross-cluster network 170, from PRF 168a to PRF 168b. In one such embodiment, cluster 160a comprises circuitry (not shown) which, based on the xmov uop, sends a signal—e.g., via cross-cluster network 170 or another suitable cross-cluster interconnect structure—to initiate a wakeup at cluster 160b in preparation for the communication of the operand value and/or in preparation of an execution of the second uop based on the operand value. Alternatively, the xmov uop is inserted into the second strand, wherein cluster 160b executes the xmov uop to request that cluster 160a communicate the operand value, via cross-cluster network 170, from PRF 168a to PRF 168b.

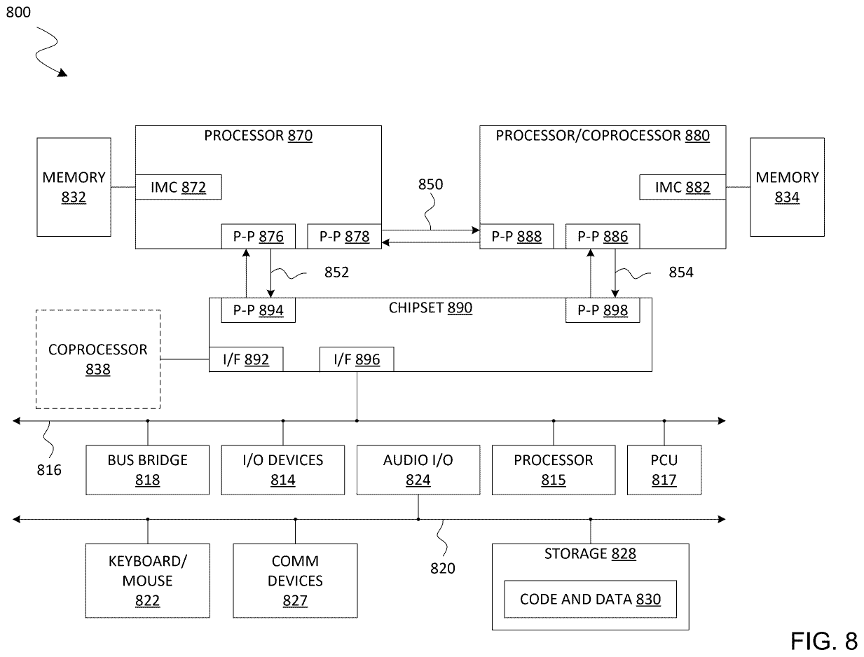

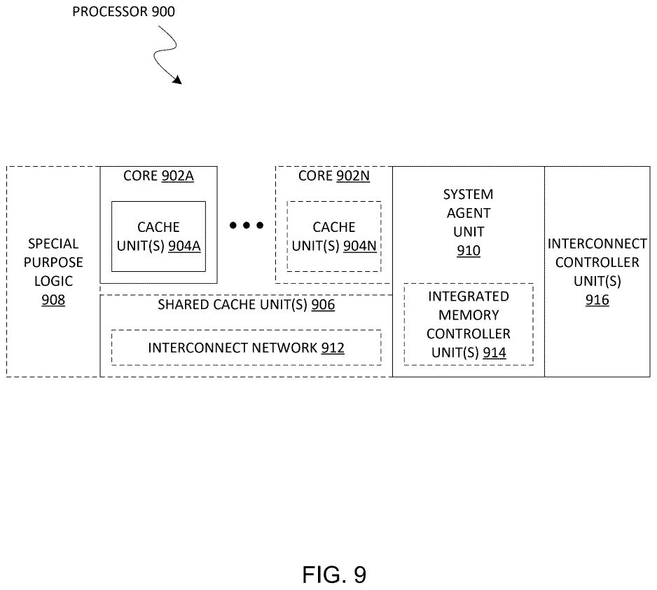

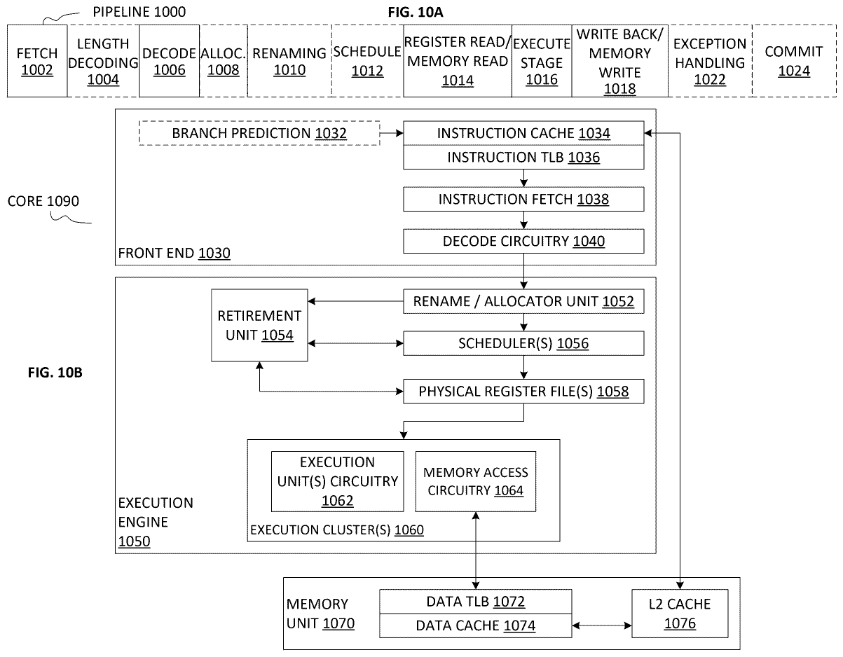

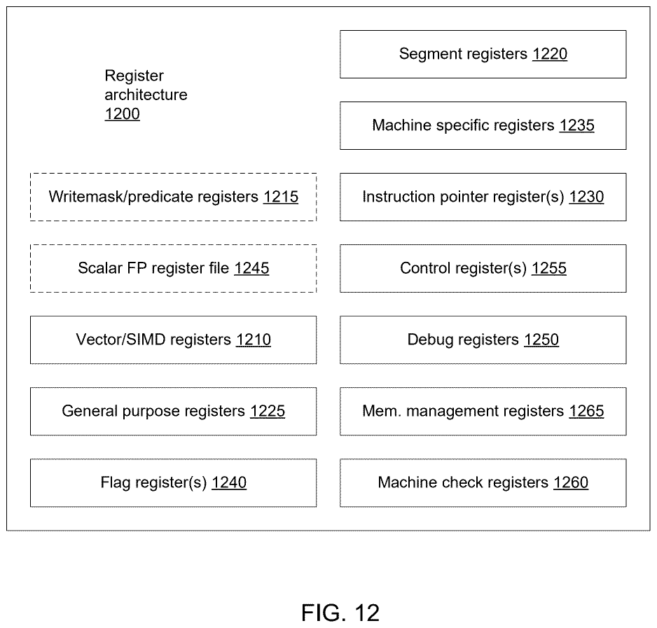

In some embodiments, circuitry of processor 110 is adapted from, and/or is incorporated with, any of various suitable processor architectures. By way of illustration and not limitation, any of various suitable embodiments of processor 110 are implemented, for example, in the processor 870 (FIG. 8), the processor/coprocessor 880 (FIG. 8), the processor 900 (FIG. 9), the pipeline 1000 (FIG. 10A), the core 1090 (FIG. 10B), and/or the register architecture 1200 (FIG. 12).

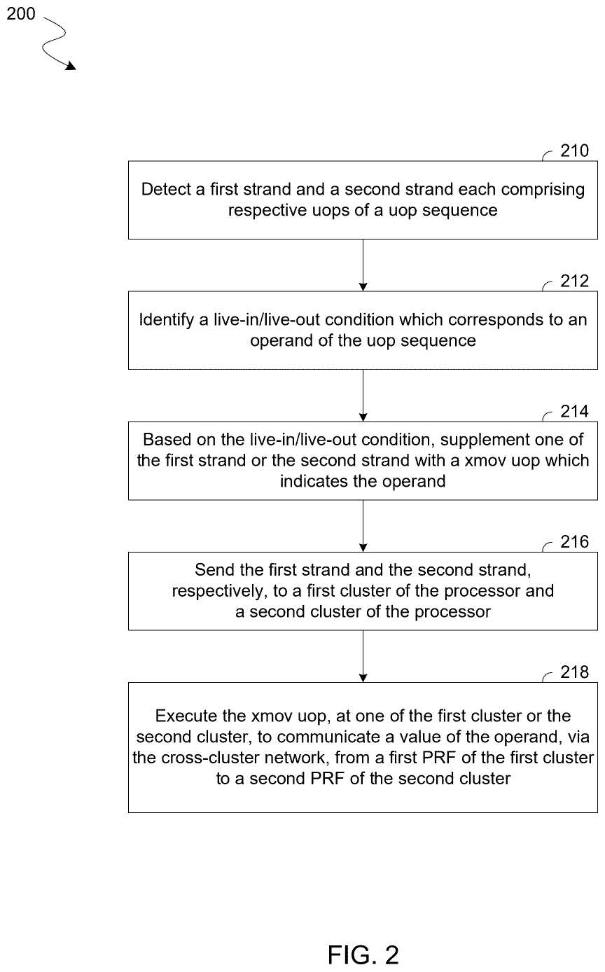

FIG. 2 shows a method 200 for identifying a processor cluster which is to receive an operand value according to an embodiment. Method 200 illustrates one example of an embodiment wherein a microoperation (uop)—referred to herein as a xmov uop—is inserted into a sequence of microoperations (uops) to indicate that the value of an operand is to be communicated between clusters of a processor. Operations such as those of method 200 are performed with any of various combinations of suitable hardware (e.g., circuitry), firmware and/or executing software which, for example, provide some or all of the functionality of processor 110.

As shown in FIG. 2, method 200 comprises (at 210) detecting a first strand of a uop sequence and a second strand of the same uop sequence. The detecting at 210 is performed by strand manager 130, for example. In some embodiments, the detecting at 210 comprises (or is otherwise based on) a designating of one or both bounds of the second strand—e.g., wherein one such bound is at least provisionally designated based (for example) on a threshold maximum number of live-in operands in a given strand, and/or a threshold maximum number of live-out operands in a given strand. In various embodiments, a bound of the second strand is additionally or alternatively designated based on a threshold maximum number of uops in a given strand.

Method 200 further comprises (at 212) identifying a live-in/live-out condition of the sequence. In an embodiment, the identifying at 212 comprises determining that a first uop of the first strand is to “produce”—e.g., load or otherwise determine—a value of an operand, and that a second uop of the second strand (which follows the first strand in the uop sequence) is to “consume”—that is, use—the value of the operand.

Based on the live-in/live-out condition detected at 212, method 200 (at 214) supplements one of the first strand or the second strand with a cross-cluster communication (“xmov”) uop which indicates the operand. For example, the uop is of a xmov type which is to identify an operand to request a communication of a value of that operand between physical registers of different respective clusters. In an embodiment, the xmov uop is inserted into one of the strands at 214 by insertion unit 140, for example.

Method 200 further comprises (at 216) sending the first strand and the second strand to a first cluster of the processor and a second cluster of the processor, respectively. In various embodiments, a cross-cluster network of the processor couples a first physical register file (PRF) of the first cluster with a second PRF of the second cluster. The cross-cluster network—such as cross-cluster network 170, for example—comprises a ring network, in some embodiments. In one embodiment, the first cluster and second cluster are selected to receive the first strand and second strand (respectively) by selector 150.

In an illustrative scenario according to one embodiment, a given one of (e.g., each of) first cluster and the second cluster comprises a queue to receive and initially enqueue a respective strand. In one such embodiment, the given cluster further comprises a reservation station which is coupled to dequeue from the queue one or more uops of the respective strand, and to schedule the execution of said one or more uops.

Method 200 further comprises (at 218) executing the xmov uop—at one of the first cluster or the second cluster—to communicate the value, via the cross-cluster network, from the first PRF of the first cluster to the second PRF of the second cluster. By way of illustration and not limitation, in some embodiments, the xmov uop is inserted into the first strand at 214, which is sent to the first cluster at 216. The inserted xmov uop is subsequently executed by the first cluster at 218 to communicate the operand value, via the cross-cluster network, from the first PRF to the second PRF.

In some alternative embodiments, the xmov uop is inserted into the second strand at 214, which is sent to the second cluster at 216. The inserted xmov uop is subsequently executed by the second cluster at 218 to request the first cluster to communicate the value of the operand, via the cross-cluster network, from the first PRF to the second PRF

In some embodiments, an additional cross-cluster network of the processor couples the first cluster with the second cluster to facilitate an early wake-up of circuitry at the second cluster in anticipation of the executing at 218. In one such embodiment, method 200 further comprises circuitry of the first cluster sending a signal, based on the xmov uop, to the second cluster via the second cross-cluster network, wherein the signal is to initiate a wakeup at the second cluster before an execution of the second uop at the second cluster. The additional “wake-up” cross-cluster network comprises a ring network, in some embodiments.

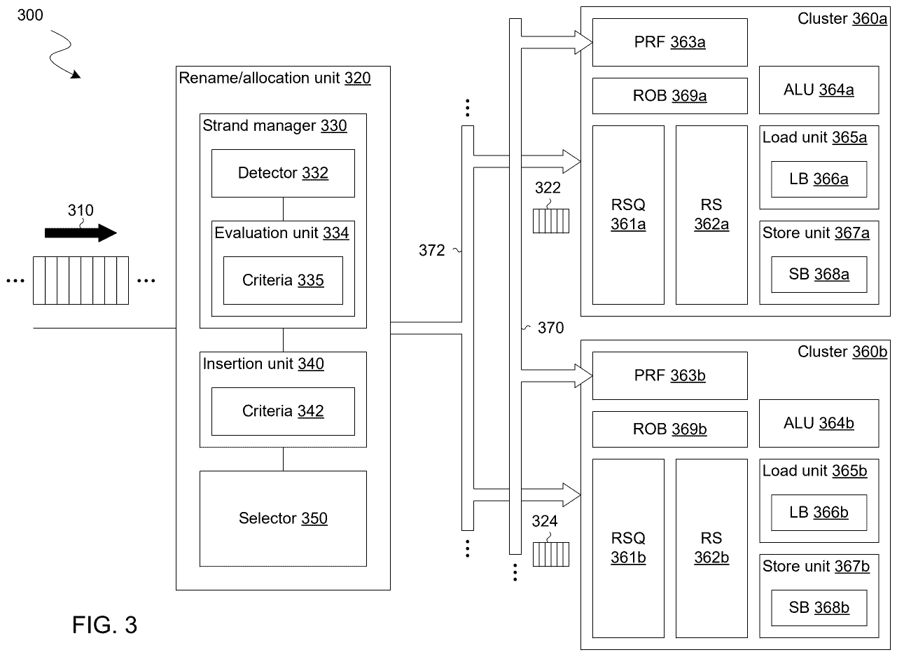

FIG. 3 shows a core 300 which facilitates a cross-cluster provisioning of operands in a processor according to an embodiment. Core 300 illustrates features of one example embodiment that provides functionality to variously insert xmov uops, each in a respective portion of uop sequence, to facilitate the communication of operand values between processor clusters. In some embodiments, core 300 provides functionality of processor 110—e.g., wherein operations of method 200 are performed with some or all of core 300.

As shown in FIG. 3, core 300 comprises a rename/allocation unit 320 and clusters 360 (such as the illustrative clusters 360a, 360b shown), which are coupled to each other via a cross-cluster network 370 and a steering network 372. In some embodiments, core 300 provides functionality such as that of processor 110—e.g., wherein rename/allocation unit 320 and clusters 360 correspond functionally to allocation unit 120 and clusters 160 (respectively), and wherein networks 370, 372 provide the respective functionality of cross-cluster network 170 and interconnect 172.

In the example embodiment shown, cluster 360a comprises a reservation station (RS) 362a, and a physical register file (PRF) 363a which, for example, provide functionality of RS 162a, and PRF 168a (respectively)—e.g., wherein cluster 360b similarly comprises a RS 362b, and a PRF 363b. To facilitate the provisioning of uops to RSs 362a, 362b, clusters 360a, 360b further comprise respective queues RSQ 361a, RSQ 361b which are each to receive a respective incoming strand that is later to be scheduled for execution.

Functionality such as that of EU(s) 164a is provided (for example) with an arithmetic logic unit (ALU) 364a, a load unit 365a, and a store unit 367a of cluster 360a—e.g., wherein functionality of EU(s) 164b is provided at cluster 360b with an ALU 364b, a load unit 365a, and a store unit 367a. In one such embodiment, load unit 365a and store unit 367a comprise—or alternatively, are coupled to operate with—a load buffer (LB) 366a and a store buffer (SB) 368a (respectively)—e.g., wherein load buffer 366a and store buffer 368a provide functionality of one or more buffers 166a. Similarly, load unit 365b and store unit 367b comprise, or are coupled to operate with, a LB 366b and a SB 368b (respectively). Furthermore, clusters 360 a, 360b comprise a reorder buffer (ROB) 369a and a ROB 369b, respectively, to facilitate the processing of uops.

Rename/allocation unit 320 is configured to receive a sequence 310 of uops (such as sequence 112), and to variously allocate some or all such uops each to a respective one of clusters 360. To facilitate cross-cluster communication of a given operand value according to some embodiments, rename/allocation unit 320 includes—or alternatively, is coupled to operate with—a strand manager 330, an insertion unit 340, and a selector 350 which, for example, provide functionality of strand manager 130, insertion unit 140, and selector 150 (respectively).

Strand manager 330 provides functionality to identify a live-in/live-out condition based on sequence 310. By way of illustration and not limitation, a detector 332 of strand manager 330 is operable to detect that a first uop and a second uop—which follows the first uop in sequence 310—are (respectively) a producer uop and corresponding consumer uop. In an embodiment, an evaluation unit 334 of strand manager 330 is operable to define or otherwise determine the various bounds which distinguish strands in sequence 310 from each other. For example, evaluation unit 334 designates the beginning and end of a strand 322 which includes the first uop, as well as the beginning and end of another strand 324 which includes the second uop. In one such embodiment, designating one or more such bounds is based on criteria 335 which (for example) includes, but is not limited to, a threshold maximum number of uops in a given strand, a threshold maximum number of producer uops and/or consumer uops in a given strand, and/or the like. However, some embodiments are not limited with respect to the particular criteria 335 which are used to determine the respective bounds of strands in sequence 310.

Based on the identification of strands 322, 324, and the respective first uop and second uop thereof, strand manager 330 identifies a live-in/live-out condition which is to be a basis for the insertion of a xmov uop in one of strands 322, 324. For example, strand manager 330 communicates to insertion unit 340 information which describes the detected live-in/live-out condition. Based on such information, insertion unit 340 inserts into one of strands 322, 324 an xmov uop, the execution of which is to facilitate a communication of an operand value between PRFs 363a, 363b via cross-cluster network 370. In an embodiment, such insertion is based on criteria 342 which (for example) includes or is otherwise based on a threshold maximum number of xmov uops in a strand, a threshold maximum distance between an xmov uop and a corresponding producer uop, a threshold minimum distance between two successive xmov uops in a strand, and/or the like.

In some embodiments, circuitry of core 300 is adapted from, and/or is incorporated with, any of various suitable processor architectures. By way of illustration and not limitation, any of various suitable embodiments of core 300 are implemented, for example, in the processor 870 (FIG. 8), the processor/coprocessor 880 (FIG. 8), the processor 900 (FIG. 9), the pipeline 1000 (FIG. 10A), the core 1090 (FIG. 10B), and/or the register architecture 1200 (FIG. 12).

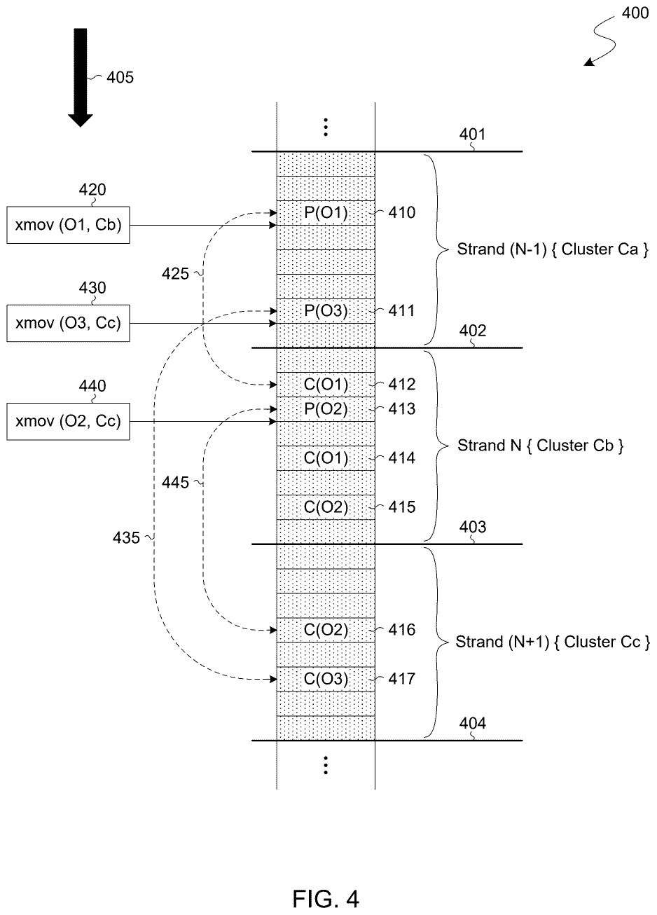

FIG. 4 shows a sequence 400 of microoperations, a strand of which is to be supplemented to facilitate cross-cluster communication according to an embodiment. Sequence 400 illustrates an example embodiment wherein one or more xmov uops are inserted into a uop strand, where each such xmov uop is based on a respective live-in/live-out condition. In some embodiments, circuitry of processor 110 or of core 300 provides processing of sequence 400—e.g., wherein operations of method 200 include or are otherwise based on such processing.

As shown in FIG. 4, sequence 400 comprises micro-operations (uops) which, as indicated by the arrow 405 shown, have a relative order with respect to each other. In an illustrative scenario according to one embodiment, sequence 400 is evaluated—e.g., by strand manager 130, strand manager 330 or other suitable circuitry—to identify the respective bounds of strands which each include one or more uops of sequence 400. In the example embodiment shown, a processor core designates or otherwise identifies a boundary 401 at a beginning of a strand (N−1) in sequence 400, and another boundary 402 between strand (N−1) and a next strand N in sequence 400. Furthermore, the core identifies a boundary 403 between strand N and a next strand (N+1), as well as a boundary 404 at an end of the strand (N+1). The particular number and sizes of strands (N+1), N, and (N+1) are merely illustrative, and some embodiments variously facilitate the identification of larger strands, smaller strands, additional strand, and/or the like.

In one such embodiment, strand (N−1) is allocated by the core to be executed by a cluster Ca of processor resources, wherein strand N is allocated to a different cluster Cb, and strand (N+1) is allocated to a third cluster Cc. To facilitate execution of strands (N−1), N, (N+1), the processor core identifies a live-in/live-out condition 425 wherein a producer uop P(O1) 410 in strand (N−1) corresponds to a consumer uop C(O1) 412 in strand N—i.e., wherein uops 410, 412 each indicate the same operand O1, and are to be executed in different respective clusters Ca, Cb. Based on live-in/live-out condition 425, the processor core inserts into strand (N−1) a uop 420—e.g., xmov(O1, Cb)—for cluster Ca to communicate the value of operand O1 to cluster Cb to facilitate execution of uop C(O1) 412.

It is to be noted that strand N comprises a subsequent instance of the same consumer uop C(O1) 414—i.e., subsequent to uop C(O1) 412 in the order indicated by arrow 405. However, since uops 412, 414 are in the same strand N, and will be executed at the same cluster Cb, execution of xmov uop 420 is sufficient to provide the operand O1 to cluster Cb for both of uops 412, 414.

Alternatively or in addition, the processor core identifies a live-in/live-out condition 435 wherein a producer uop P(O3) 411 in strand (N-1) corresponds to a consumer uop C(O3) 417 in strand (N+1)—i.e., wherein uops 411, 417 each indicate the same operand O3, and are to be executed in different respective clusters Ca, Cc. Based on live-in/live-out condition 435, the processor core inserts into strand (N−1) a uop 430—e.g., xmov(O3, Cc)—for cluster Ca to communicate the value of operand O3 to cluster Cc to facilitate execution of uop C(O3) 417.

Alternatively or in addition, the processor core identifies a live-in/live-out condition 445 wherein a producer uop P(O2) 413 in strand N corresponds to a consumer uop C(O2) 416 in strand (N+1)—i.e., wherein uops 413, 416 each indicate the same operand O2, and are to be executed in different respective clusters Cb, Cc. Based on live-in/live-out condition 445, the processor core inserts into strand N a uop 440—e.g., xmov(O2, Cc)—for cluster Cb to communicate the value of operand O2, to cluster Cc, to facilitate execution of uop C(O2) 416. It is to be noted that strand N comprises an earlier instance of the consumer uop C(O2) 415—i.e., earlier than the uop C(O2) 416 in strand (N+1). However, since uops 413, 415 are in the same strand N, and will be executed at the same cluster Cb, no xmov uop is needed for communication of operand O2 to cluster Cb.

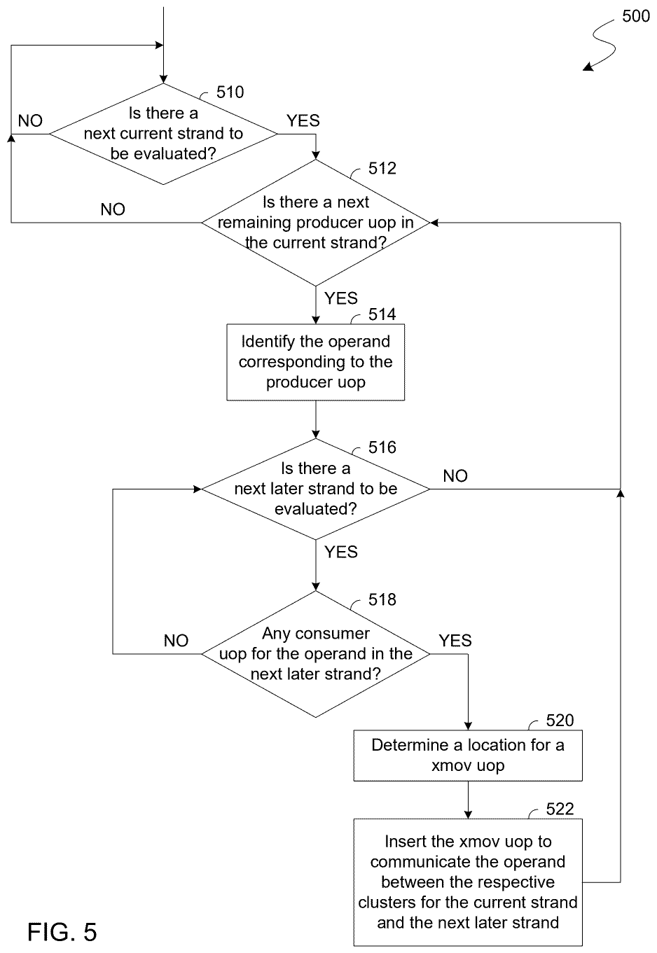

FIG. 5 shows a method 500 for providing cross-cluster communication microoperations in respective strands according to an embodiment. Operations such as those of method 500 are performed with any of various combinations of suitable hardware (e.g., circuitry), firmware and/or executing software which, for example, provide functionality of processor 110 or of core 300—e.g., wherein method 500 includes or is otherwise based on some or all operations of method 200.

As shown in FIG. 5, method 500 comprises performing an evaluation (at 510) to detect for an availability, if any, of some strand in a uop (uop) sequence to serve as the next “current” strand—i.e., the next strand which is to be evaluated as a candidate for the possible insertion of one or more xmov uops. For example, the evaluating at 510 includes identifying one or more bounds—e.g., at least provisionally defined bounds—of a strand which is immediately subsequent to the youngest strand (if any) evaluated by method 500.

Where it is determined at 510 that no such next current strand is available, method 500 repeats the evaluating at 510—e.g., until a next current strand is detected. Where it is instead determined at 510 that some next current strand is available, method 500 detects (at 512) for an availability, if any, of some next remaining producer uop of the current strand—i.e., a uop which has yet to be evaluated as possibly being a basis for the insertion of a xmov uop into the current strand.

Where it is determined at 512 that the current strand does not have any more remaining producer uops, method 500 (at 510) performs another instance of the evaluating at 510. Where it is instead determined at 512 that the current strand does include some next remaining producer uop, method 500 (at 514) identifies an operand which corresponds to—e.g., which is generated by—that producer uop. Based on the operand which is most recently identified at 514, method 500 detects (at 516) for an availability, if any, of some other strand in the uop sequence to serve as the next “later” strand—i.e., another strand, after the current strand, which has yet to be evaluated as a basis for possible insertion of one or more xmov uops into the current strand.

Where it is determined at 516 that no strand is currently available to serve as the next later strand, method 500 performs another instance of the detecting at 512. Where it is instead determined at 516 that a strand is available to serve as the next later strand, method 500 performs another evaluation (at 518) to determine whether the next later strand, which was most recently detected at 516, includes a “qualified” consumer uop—i.e., a uop which includes an operand that corresponds to (e.g., which is the same as) the one most recently identified at 514.

Where it is determined at 518 that the next later strand does not include any such qualified consumer uop, method 500 performs another instance of the detecting at 516. Where it is instead determined at 518 that the next later strand does include a qualified consumer uop, method 500 (at 520) determines a location in the current strand for a xmov uop. In one such embodiment, the location is to be after that of the producer uop most recently detected at 512. Subsequently, method 500 inserts into the current strand (at 522) a xmov uop which is to be subsequently executed to communicate the operand between clusters that are each to receive a different respective one of the current strand or the next strand. After the inserting at 522, method 500 performs another instance of the detecting at 512.

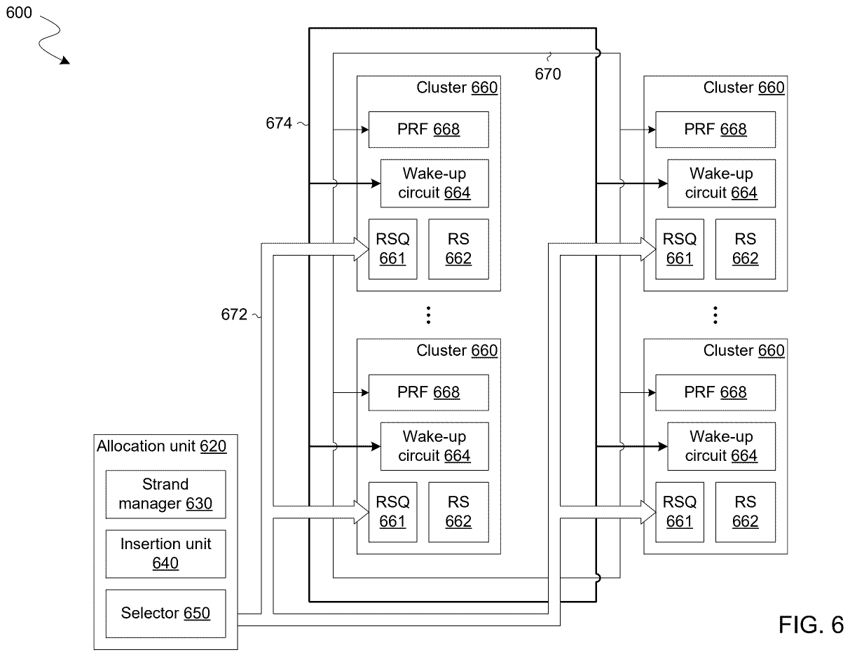

FIG. 6 shows a processor 600 for enabling a wake-up of circuitry at a processor cluster according to an embodiment. Processor 600 illustrates features of one example embodiment which enables advance preparation for cross-cluster provisioning of an operand value. In some embodiments, processor 600 provides functionality such as that of processor 110, or core 300—e.g., wherein operations of one of methods 200, 500 are performed with some or all of processor 600.

In some embodiments, circuitry of processor 600 is adapted from, and/or is incorporated with, any of various suitable processor architectures. By way of illustration and not limitation, any of various suitable embodiments of processor 600 are implemented, for example, in the processor 870 (FIG. 8), the processor/coprocessor 880 (FIG. 8), the processor 900 (FIG. 9), the pipeline 1000 (FIG. 10A), the core 1090 (FIG. 10B), and/or the register architecture 1200 (FIG. 12).

As shown in FIG. 6, processor 600 comprises an allocation unit 620 and clusters 660 which are variously coupled to each other and to allocation unit 620 via a cross-cluster network 670 and a steering network 672. In some embodiments, processor 600 provides functionality such as that of processor 110—e.g., wherein allocation unit 620 and clusters 660 correspond functionally to allocation unit 120 and clusters 160 (respectively). For example, allocation unit 620 includes—or alternatively, is coupled to operate with—a strand manager 630, an insertion unit 640, and a selector 650 which provide functionality such as that of strand manager 130, insertion unit 140, and selector 150 (respectively)—e.g., wherein networks 670, 672 provide the respective functionality of cross-cluster network 170 and interconnect 172. In the example embodiment shown, a given cluster 660 comprises a reservation station (RS) 662, and a PRF 668 which, for example, provide functionality of RS 162a, and PRF 168a (respectively). Furthermore, the given cluster 660 comprises a queue RSQ 661 which is to receive an incoming strand for later provisioning to the RS 662 of that cluster 660.

To facilitate cross-cluster communication of an operand value—e.g., by the execution of a xmov uop as described herein, some embodiments further provide additional circuit structures which enable a relatively early wake-up of circuitry at a cluster which is to receive said operand value. By way of illustration and not limitation, processor 600 further comprises a wake-up network 674 which couples respective wake-up circuits 664 of cluster 660 to each other. In the example embodiment shown, wake-up network 674 comprises a ring network topology—e.g., similar to one of cross-cluster network 670.

For a given “source” cluster 660—e.g., one is to locally execute an xmov uop for communicating an operand value—the wake-up circuit 664 of said source cluster 660 is operable to detect the xmov uop which is to be locally executed. Based on the detected xmov uop, the wake-up circuit 664 of the source cluster 660 communicates a wake-up signal, via wake-up network 674, to other wake-up circuit 664 at a “target” cluster 660 which is to receive the operand value via cross-cluster network 670. In an embodiment, the wake-up signal causes circuitry at the target cluster 660—e.g., circuitry of an ALU, a PRF, a load pipeline, a store pipeline, or the like—to transition from a relatively inactive (e.g., low power) mode of operation to one which better facilitates the communication, storing, and/or other use of the operand value.

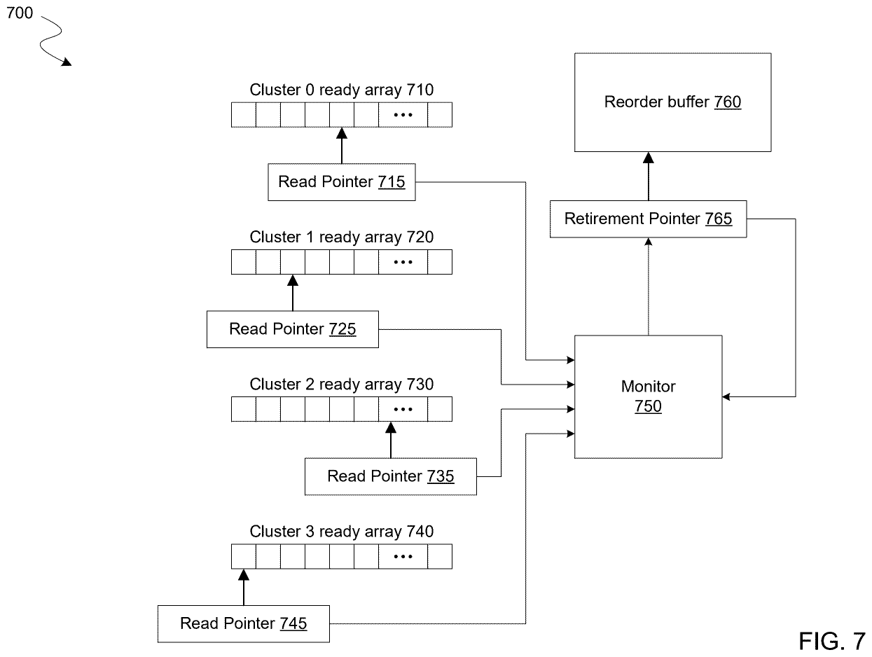

FIG. 7 shows a processor 700 for identifying microoperations to be retired at a processor comprising multiple clusters according to an embodiment. Processor 700 illustrates features of one example embodiment which provides, for each of multiple clusters, a respective array of bits which each identify whether a corresponding uop is ready to be retired. In some embodiments, processor 700 provides functionality such as that of system 100, 300, or processor 600—e.g., wherein operations of one of methods 200, 500 are performed with some or all of processor 700.

As shown in FIG. 7, processor 700 comprises ready arrays 710, 720, 730, 740 which correspond to a different respective cluster of processor. In the example embodiment shown, cluster 0 ready array 710 comprises bits which each correspond to a different respective uop that has been provided to a cluster 0 of processor 700. For a given bit of cluster 0 ready array 710, a value of said bit indicates whether the corresponding uop is ready to be retired. In one such embodiment, cluster 1 ready array 720 comprises bits which each correspond to a different respective uop provided to a cluster 1 of processor 700, the bits of cluster 1 ready array 720 each indicating whether the corresponding uop is ready to be retired. Furthermore, cluster 2 ready array 730 comprises bits which each correspond to a different respective uop provided to a cluster 2, the bits each indicating whether the corresponding uop is ready to be retired. Further still, cluster 3 ready array 740 comprises bits which each correspond to a different respective uop provided to a cluster 3 of processor 700, the bits each indicating whether the corresponding uop is ready to be retired.

In one such embodiment, processor 700 further comprises read pointers 715, 725, 735, 745 which are configured to variously read respective bits of ready arrays 710, 720, 730, 740. A monitor 750 of processor 700—the monitor 750 coupled to read pointers 715, 725, 735, 745—provides functionality to determine, for a given strand (which is executed at a corresponding cluster), a youngest uop of the strand which is ready to be retired—e.g., wherein any older uops of the strand are also ready to retire by virtue of an order of execution of the strand.

Based on information from the read pointers 715, 725, 735, 745, monitor 750 identifies when a complete strand is ready to be retired. For example, monitor 750 updates a retirement pointer 765 to indicate to a reorder buffer 760 that an entire strand is ready to be retired at one time. Accordingly, some embodiments facilitate the retirement of multiple strands in quick succession with each other—e.g., wherein the evaluation of one strand after the retirement of a preceding strand is relatively time efficient and/or power efficient.

In some embodiments, circuitry of processor 700 is adapted from, and/or is incorporated with, any of various suitable processor architectures. By way of illustration and not limitation, any of various suitable embodiments of processor 700 are implemented, for example, in the processor 870 (FIG. 8), the processor/coprocessor 880 (FIG. 8), the processor 900 (FIG. 9), the pipeline 1000 (FIG. 10A), and/or the core 1090 (FIG. 10B).

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous. Though the exemplary system 800 is shown to have two processors, the system may have three or more processors, or may be a single processor system.

Processors 870 and 880 are shown including integrated memory controller (IMC) circuitry 872 and 882, respectively. Processor 870 also includes as part of its interconnect controller point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a co-processor 838 via an interface 892. In some examples, the co-processor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via P-P interconnect, such that either or both processors'local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be one or more non-transitory machine-readable storage media as described below, such as a disk drive or other mass storage device which may include instructions/code and data 830 in some examples. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 9 illustrates a block diagram of an example processor 900 that may have more than one core and an integrated memory controller. The solid lined boxes illustrate a processor 900 with a single core 902A, a system agent unit circuitry 910, a set of one or more interconnect controller unit(s) circuitry 916, while the optional addition of the dashed lined boxes illustrates an alternative processor 900 with multiple cores 902A-N, a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902A-N being one or more general purpose cores (e.g., general purpose in-order cores, general purpose out-of-order cores, or a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904A-N within the cores 902A-N, a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902A-N.

In some examples, one or more of the cores 902A-N are capable of multi-threading. The system agent unit circuitry 910 includes those components coordinating and operating cores 902A-N. The system agent unit circuitry 910 may include, for example, power control unit (PCU) circuitry and/or display unit circuitry (not shown). The PCU may be or may include logic and components needed for regulating the power state of the cores 902A-N and/or the special purpose logic 908 (e.g., integrated graphics logic). The display unit circuitry is for driving one or more externally connected displays.

The cores 902A-N may be homogenous in terms of instruction set architecture (ISA). Alternatively, the cores 902A-N may be heterogeneous in terms of ISA; that is, a subset of the cores 902A-N may be capable of executing an ISA, while other cores may be capable of executing only a subset of that ISA or another ISA.

### Exemplary Core Architectures-in-Order and Out-of-Order Core Block Diagram

FIG. 10A is a block diagram illustrating both an exemplary in-order pipeline and an exemplary register renaming, out-of-order issue/execution pipeline according to examples. FIG. 10B is a block diagram illustrating both an exemplary example of an in-order architecture core and an exemplary register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to an execution engine unit circuitry 1050, and both are coupled to a memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction circuitry 1032 coupled to an instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to a data cache circuitry 1074 coupled to a level 2 (L2 ) cache circuitry 1076. In one exemplary example, the memory access circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to the level 2(L2) cache circuitry 1076 in the memory unit circuitry 1070. In one example, the instruction cache 1034 and the data cache 1074 are combined into a single instruction and data cache (not shown) in L2 cache circuitry 1076, a level 3 (L3 ) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Exemplary Execution Unit(s) Circuitry.

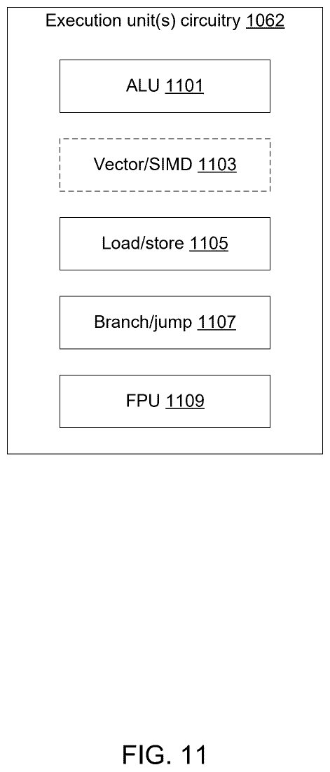

FIG. 11 illustrates examples of execution unit(s) circuitry, such as execution unit(s) circuitry 1062 of FIG. 10B. As illustrated, execution unit(s) circuity 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1200 may, for example, be used in physical register file(s) circuitry 1058.

Techniques and architectures for communicating information in a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor comprises a first cluster comprising a first physical register file (PRF), a second cluster comprising a second PRF, a cross-cluster network which couples the first PRF with the second PRF, first circuitry to detect a first strand and a second strand each comprising respective micro-operations (uops) of a sequence of uops, second circuitry coupled to the first circuitry, the second circuitry to identify a condition wherein a first micro-operation (uop) of the first strand is to produce a value of an operand, and a second uop of the second strand is to consume the value of the operand, third circuitry coupled to the second circuitry, wherein, based on the condition, the third circuitry is to supplement one of the first strand or the second strand with a third uop of a xmov type which is to request a communication between physical registers of different respective clusters, wherein the first uop indicates the operand, and fourth circuitry coupled to send the first strand and the second strand to the first cluster and the second cluster, respectively.

In one or more second embodiments, further to the first embodiment, the one of the first strand of the second strand is the first strand, and the first cluster is to execute the third uop to communicate the value, via the cross-cluster network, from the first PRF to the second PRF.

In one or more third embodiments, further to the second embodiment, the cross-cluster network is a first cross-cluster network, the processor further comprises a second cross-cluster network which couples the first cluster with the second cluster, and the first cluster comprises fifth circuitry which, based on the third uop, is to send a signal, via the second cross-cluster network, to initiate a wakeup at the second cluster before an execution of the second uop at the second cluster.

In one or more fourth embodiments, further to the third embodiment, the second cross-cluster network comprises a ring network.

In one or more fifth embodiments, further to the first embodiment or the second embodiment, the one of the first strand of the second strand is the second strand, and the second cluster comprises fifth circuitry to execute the third uop to request the first cluster to communicate the value, via the cross-cluster network, from the first PRF to the second PRF.

In one or more sixth embodiments, further to the first embodiment or the second embodiment, the first circuitry to detect the first strand and the second strand comprises the first circuitry to designate a bound of the second strand based on one of a threshold maximum number of live-in operands, or a threshold maximum number of live-out operands.

In one or more seventh embodiments, further to the sixth embodiment, the first circuitry is to designate the bound of the second strand further based on a threshold maximum number of uops.

In one or more eighth embodiments, further to the first embodiment or the second embodiment, the cross-cluster network comprises a ring network.

In one or more ninth embodiments, further to the first embodiment or the second embodiment, the first cluster and the second cluster each comprise a respective queue to receive a respective strand, and a respective reservation station configured to dequeue, from the respective queue, one or more uops of the respective strand, and to schedule an execution of one or more uops of the respective strand.

In one or more tenth embodiments, a method at a processor comprises detecting a first strand and a second strand each comprising respective micro-operations (uops) of a sequence of uops, identifying a condition wherein a first micro-operation (uop) of the first strand is to produce a value of an operand, and a second uop of the second strand is to consume the value of the operand, based on the condition, supplementing one of the first strand or the second strand with a third uop of a xmov type which is to request a communication between physical registers of different respective clusters, wherein the first uop indicates the operand, and sending the first strand and the second strand to a first cluster of the processor and a second cluster of the processor, respectively, wherein a cross-cluster network of the processor couples a first physical register file (PRF) of the first cluster with a second PRF of the second cluster.

In one or more eleventh embodiments, further to the tenth embodiment, the one of the first strand of the second strand is the first strand, and the method further comprises executing the third uop at the first cluster to communicate the value, via the cross-cluster network, from the first PRF to the second PRF.

In one or more twelfth embodiments, further to the eleventh embodiment, the cross-cluster network is a first cross-cluster network, a second cross-cluster network of the processor couples the first cluster with the second cluster, and the method further comprises based on the third uop, sending a signal, from the first cluster via the second cross-cluster network, to initiate a wakeup at the second cluster before an execution of the second uop at the second cluster.

In one or more thirteenth embodiments, further to the twelfth embodiment, the second cross-cluster network comprises a ring network.

In one or more fourteenth embodiments, further to the tenth embodiment or the eleventh embodiment, the one of the first strand of the second strand is the second strand, and the method further comprises executing the third uop at the second cluster to request the first cluster to communicate the value, via the cross-cluster network, from the first PRF to the second PRF.

In one or more fifteenth embodiments, further to the tenth embodiment or the eleventh embodiment, the method further comprises designating a bound of the second strand based on one of a threshold maximum number of live-in operands, or a threshold maximum number of live-out operands.

In one or more sixteenth embodiments, further to the fifteenth embodiment, the bound of the second strand is designated further based on a threshold maximum number of uops.

In one or more seventeenth embodiments, further to the tenth embodiment or the eleventh embodiment, the cross-cluster network comprises a ring network.

In one or more eighteenth embodiments, further to the tenth embodiment or the eleventh embodiment, the first cluster and the second cluster each comprise a respective queue to receive a respective strand, and a respective reservation station coupled to dequeue from the respective queue one or more uops of the respective strand, and to schedule an execution of one or more uops of the respective strand.

In one or more nineteenth embodiments, a system comprises a memory, a memory controller, and a processor coupled to the memory via the memory controller, the processor comprising a first cluster comprising a first physical register file (PRF), a second cluster comprising a second PRF, a cross-cluster network which couples the first PRF with the second PRF, first circuitry to detect a first strand and a second strand each comprising respective micro-operations (uops) of a sequence of uops, second circuitry coupled to the first circuitry, the second circuitry to identify a condition wherein a first micro-operation (uop) of the first strand is to produce a value of an operand, and a second uop of the second strand is to consume the value of the operand, third circuitry coupled to the second circuitry, wherein, based on the condition, the third circuitry is to supplement one of the first strand or the second strand with a third uop of a xmov type which is to request a communication between physical registers of different respective clusters, wherein the first uop indicates the operand, and fourth circuitry coupled to send the first strand and the second strand to the first cluster and the second cluster, respectively.

In one or more twentieth embodiments, further to the nineteenth embodiment, the one of the first strand of the second strand is the first strand, and the first cluster is to execute the third uop to communicate the value, via the cross-cluster network, from the first PRF to the second PRF.

In one or more twenty-first embodiments, further to the twentieth embodiment, the cross-cluster network is a first cross-cluster network, the processor further comprises a second cross-cluster network which couples the first cluster with the second cluster, and the first cluster comprises fifth circuitry which, based on the third uop, is to send a signal, via the second cross-cluster network, to initiate a wakeup at the second cluster before an execution of the second uop at the second cluster.

In one or more twenty-second embodiments, further to the twenty-first embodiment, the second cross-cluster network comprises a ring network.

In one or more twenty-third embodiments, further to the nineteenth embodiment or the twentieth embodiment, the one of the first strand of the second strand is the second strand, and the second cluster comprises fifth circuitry to execute the third uop to request the first cluster to communicate the value, via the cross-cluster network, from the first PRF to the second PRF.

In one or more twenty-fourth embodiments, further to the nineteenth embodiment or the twentieth embodiment, the first circuitry to detect the first strand and the second strand comprises the first circuitry to designate a bound of the second strand based on one of a threshold maximum number of live-in operands, or a threshold maximum number of live-out operands.

In one or more twenty-fifth embodiments, further to the twenty-fourth embodiment, the first circuitry is to designate the bound of the second strand further based on a threshold maximum number of uops.

In one or more twenty-sixth embodiments, further to the nineteenth embodiment or the twentieth embodiment, the cross-cluster network comprises a ring network.

In one or more twenty-seventh embodiments, further to the nineteenth embodiment or the twentieth embodiment, the first cluster and the second cluster each comprise a respective queue to receive a respective strand, and a respective reservation station configured to dequeue, from the respective queue, one or more uops of the respective strand, and to schedule an execution of one or more uops of the respective strand.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
a first cluster comprising a first physical register file (PRF);
a second cluster comprising a second PRF;
a cross-cluster network which couples the first PRF with the second PRF;
first circuitry to detect a first strand and a second strand each comprising respective micro-operations (uops) of a sequence of uops;
second circuitry coupled to the first circuitry, the second circuitry to identify a condition wherein:
a first micro-operation (uop) of the first strand is to produce a value of an operand; and
a second uop of the second strand is to consume the value of the operand;
third circuitry coupled to the second circuitry, wherein, based on the condition, the third circuitry is to supplement one of the first strand or the second strand with a third uop of a xmov type which is to request a communication between physical registers of different respective clusters, wherein the first uop indicates the operand; and
fourth circuitry coupled to send the first strand and the second strand to the first cluster and the second cluster, respectively.

2. The processor of claim 1, wherein:
the one of the first strand of the second strand is the first strand; and
the first cluster is to execute the third uop to communicate the value, via the cross-cluster network, from the first PRF to the second PRF.

3. The processor of claim 2, wherein:
the cross-cluster network is a first cross-cluster network;
the processor further comprises a second cross-cluster network which couples the first cluster with the second cluster; and
the first cluster comprises fifth circuitry which, based on the third uop, is to send a signal, via the second cross-cluster network, to initiate a wakeup at the second cluster before an execution of the second uop at the second cluster.

4. The processor of claim 3, wherein the second cross-cluster network comprises a ring network.

5. The processor of claim 1, wherein:
the one of the first strand of the second strand is the second strand; and
the second cluster comprises fifth circuitry to execute the third uop to request the first cluster to communicate the value, via the cross-cluster network, from the first PRF to the second PRF.

6. The processor of claim 1, wherein the first circuitry to detect the first strand and the second strand comprises the first circuitry to designate a bound of the second strand based on one of:
a threshold maximum number of live-in operands; or
a threshold maximum number of live-out operands.

7. The processor of claim 6, wherein the first circuitry is to designate the bound of the second strand further based on a threshold maximum number of uops.

8. The processor of claim 1, wherein the cross-cluster network comprises a ring network.

9. The processor of claim 1, wherein the first cluster and the second cluster each comprise:
a respective queue to receive a respective strand; and
a respective reservation station configured to dequeue, from the respective queue, one or more uops of the respective strand, and to schedule an execution of one or more uops of the respective strand.

10. A method at a processor, the method comprising:
detecting a first strand and a second strand each comprising respective micro-operations (uops) of a sequence of uops;
identifying a condition wherein:
a first micro-operation (uop) of the first strand is to produce a value of an operand; and
a second uop of the second strand is to consume the value of the operand;
based on the condition, supplementing one of the first strand or the second strand with a third uop of a xmov type which is to request a communication between physical registers of different respective clusters, wherein the first uop indicates the operand; and
sending the first strand and the second strand to a first cluster of the processor and a second cluster of the processor, respectively, wherein a cross-cluster network of the processor couples a first physical register file (PRF) of the first cluster with a second PRF of the second cluster.

11. The method of claim 10, wherein:
the one of the first strand of the second strand is the first strand; and
the method further comprises executing the third uop at the first cluster to communicate the value, via the cross-cluster network, from the first PRF to the second PRF.

12. The method of claim 11, wherein:
the cross-cluster network is a first cross-cluster network;
a second cross-cluster network of the processor couples the first cluster with the second cluster; and
the method further comprises:
based on the third uop, sending a signal, from the first cluster via the second cross-cluster network, to initiate a wakeup at the second cluster before an execution of the second uop at the second cluster.

13. The method of claim 10, wherein:
the one of the first strand of the second strand is the second strand; and
the method further comprises executing the third uop at the second cluster to request the first cluster to communicate the value, via the cross-cluster network, from the first PRF to the second PRF.

14. The method of claim 10, further comprising designating a bound of the second strand based on one of:
a threshold maximum number of live-in operands; or
a threshold maximum number of live-out operands.

15. The method of claim 14, wherein the bound of the second strand is designated further based on a threshold maximum number of uops.

16. A system comprising:
a memory;
a memory controller; and
a processor coupled to the memory via the memory controller, the processor comprising:
a first cluster comprising a first physical register file (PRF);
a second cluster comprising a second PRF;
a cross-cluster network which couples the first PRF with the second PRF;
first circuitry to detect a first strand and a second strand each comprising respective micro-operations (uops) of a sequence of uops;
second circuitry coupled to the first circuitry, the second circuitry to identify a condition wherein:
a first micro-operation (uop) of the first strand is to produce a value of an operand; and
a second uop of the second strand is to consume the value of the operand;
third circuitry coupled to the second circuitry, wherein, based on the condition, the third circuitry is to supplement one of the first strand or the second strand with a third uop of a xmov type which is to request a communication between physical registers of different respective clusters, wherein the first uop indicates the operand; and
fourth circuitry coupled to send the first strand and the second strand to the first cluster and the second cluster, respectively.

17. The system of claim 16, wherein:
the one of the first strand of the second strand is the first strand; and
the first cluster is to execute the third uop to communicate the value, via the cross-cluster network, from the first PRF to the second PRF.

18. The system of claim 17, wherein:
the cross-cluster network is a first cross-cluster network;
the processor further comprises a second cross-cluster network which couples the first cluster with the second cluster; and
the first cluster comprises fifth circuitry which, based on the third uop, is to send a signal, via the second cross-cluster network, to initiate a wakeup at the second cluster before an execution of the second uop at the second cluster.

19. The system of claim 16, wherein:
the one of the first strand of the second strand is the second strand; and
the second cluster comprises fifth circuitry to execute the third uop to request the first cluster to communicate the value, via the cross-cluster network, from the first PRF to the second PRF.

20. The system of claim 16, wherein the first circuitry to detect the first strand and the second strand comprises the first circuitry to designate a bound of the second strand based on one of:
a threshold maximum number of live-in operands; or
a threshold maximum number of live-out operands.
